(19) United States
(12) Patent Application Publication
(10) Pub. No.: US 2025/0102666 A1
(43) Pub. Date: Mar. 27, 2025

(54) SIGNAL PROCESSING DEVICE, SIGNAL PROCESSING METHOD, AND RADAR DEVICE

(71) Applicant: Mitsubishi Electric Corporation, Tokyo (JP)

(72) Inventors: Tetsuro FURUTA, Tokyo (JP); Satoshi KAGEME, Tokyo (JP)

(73) Assignee: Mitsubishi Electric Corporation, Tokyo (JP)

(21) Appl. No.: 18/972,370

(22) Filed: Dec. 6, 2024

Related U.S. Application Data
(63) Continuation of application No. PCT/JP2022/029868, filed on Aug. 4, 2022.

(51) Int. Cl. G01S 13/89; G01S 13/58; G01S 13/931

(52) U.S. Cl. CPC G01S 13/89; G01S 13/583; G01S 13/931

(57) ABSTRACT

A signal processing device is configured to include a map generating unit to acquire a reception signal of a reflected wave from a reception unit that receives the reflected wave by an object present around a mobile object, and generate a range Doppler map indicating a signal strength level of the reception signal, and an altitude standard deviation calculating unit to calculate a standard deviation of an altitude at which the object is present on a basis of the range Doppler map generated by the map generating unit. Further, the signal processing device includes a collision determining unit to determine whether or not the object is present at a height at which there is a possibility of collision between the mobile object and the object on the basis of the standard deviation calculated by the altitude standard deviation calculating unit.

### CROSS REFERENCE TO RELATED APPLICATIONS

This application is a Continuation of PCT International Application No. PCT/JP2022/029868 filed on Aug. 4, 2022, all of which is hereby expressly incorporated by reference into the present application.

### TECHNICAL FIELD

The present disclosure relates to a signal processing device, a signal processing method, and a radar device.

### BACKGROUND ART

There is a radar device (hereinafter referred to as a “conventional radar device”) that determines whether or not an object is present at a height at which there is a possibility of collision between a mobile object and the object. There is a driving assistance system having a function of braking a mobile object when a determination result of a conventional radar device is acquired and the determination result indicates that an object is present at a height at which there is a possibility of collision. In a multipath environment in which a multipath wave from a target object is included in a reflected wave from the target object in addition to a direct wave from the target object, the estimation accuracy of the altitude of the target object by the conventional radar device deteriorates, and as a result, the conventional radar device may make an erroneous determination.

For example, Patent Literature 1 discloses a radar device that estimates the altitude of a target object that is an object.

The radar device disclosed in Patent Literature 1 includes a plurality of sensor units, a variance calculating unit, and a data selecting unit in order to suppress deterioration of estimation accuracy of an altitude in a multipath environment. Each sensor unit includes a transmission and reception unit that receives a reflected wave from a target object, and a position measuring unit that measures an altitude of the target object on the basis of a reception signal of the reflected wave. The variance calculating unit calculates a variance of the altitude measured by the sensor unit included in each combination including all of the plurality of sensor units or some of the plurality of sensor units. The data selecting unit selects a combination that minimizes the variance calculated by the variance calculating unit from a plurality of combinations, and calculates an average value of altitudes measured by the sensor units included in the selected combination as the altitude of the target object.

### CITATION LIST

### Patent Literatures

Patent Literature 1: JP 2012-189474 A

### SUMMARY OF INVENTION

### Technical Problem

The radar device disclosed in Patent Literature 1 has a problem that it is necessary to include a plurality of sensor units.

The present disclosure has been made to solve the above problems, and an object of the present disclosure is to provide a signal processing device capable of determining whether or not an object is present at a height at which there is a possibility of collision between a mobile object and the object on the basis of a reception signal of a reflected wave received by only one reception unit in a multipath environment.

### Solution to Problem

A signal processing device according to the present disclosure includes processing circuitry configured to: acquire a reception signal of a reflected wave from a receiver that receives the reflected wave by an object present around a mobile object, and generate a range Doppler map indicating a signal strength level of the reception signal; calculate a standard deviation of an altitude at which the object is present on a basis of the generated range Doppler map; calculate a range interval at which a direct wave from the object included in the reflected wave and a multipath wave from the object included in the reflected wave interfere with each other on a basis of a generated range Doppler map; and determine whether or not the object is present at a height at which there is a possibility of collision between the mobile object and the object on a basis of the calculated standard deviation and the calculated range interval.

### Advantageous Effects of Invention

According to the present disclosure, in a multipath environment, it is possible to determine whether or not an object is present at a height at which there is a possibility of collision between a mobile object and the object on the basis of a reception signal of a reflected wave received by only one reception unit.

### BRIEF DESCRIPTION OF DRAWINGS

FIG. 1 is a configuration diagram illustrating a radar device according to a first embodiment.

FIG. 2 is a hardware configuration diagram illustrating hardware of a signal processing device 4 according to the first embodiment.

FIG. 3 is a hardware configuration diagram of a computer in a case where the signal processing device 4 is implemented by software, firmware, or the like.

FIG. 4 is a flowchart illustrating a signal processing method that is a processing procedure of the signal processing device 4.

FIG. 5 is an explanatory diagram illustrating an example of an RD map generated by a map generating unit 13.

FIG. 6 is an explanatory diagram illustrating a positional relationship between a vehicle and an upper object and a reflected wave from the upper object.

FIG. 7 is an explanatory diagram illustrating a relationship between a ground range in a case where an object is an upper object, a front object, or a lower object and power of a reception signal s in a case where a direct wave and a multipath wave are superimposed on each other.

FIG. 8 is an explanatory diagram illustrating a setting example of a first threshold Th_{UP,r}.

FIG. 9 is an explanatory diagram illustrating an example of setting a second threshold Th_{DW,r}.

FIG. 10 is an explanatory diagram illustrating an example of angle measurement values of elevation angles of an upper object, a front object, and a lower object which are objects.

FIG. 11 is an explanatory diagram illustrating an example of standard deviations of altitudes of an upper object, a front object, and a lower object which are objects.

FIG. 12 is an explanatory diagram illustrating an example of standard deviations of reception signal power of respective reflected waves of an upper object, a front object, and a lower object which are objects.

FIG. 13 is a flowchart illustrating determination processing of a determination processing unit 17c.

FIG. 14 is a configuration diagram illustrating a radar device according to a second embodiment.

FIG. 15 is a hardware configuration diagram illustrating hardware of the signal processing device 4 according to the second embodiment.

FIG. 16 is an explanatory diagram illustrating a plurality of objects having different azimuth angles with respect to a vehicle.

### DESCRIPTION OF EMBODIMENTS

Hereinafter, in order to describe the present disclosure in more detail, modes for carrying out the present disclosure will be described with reference to the accompanying drawings.

### First Embodiment

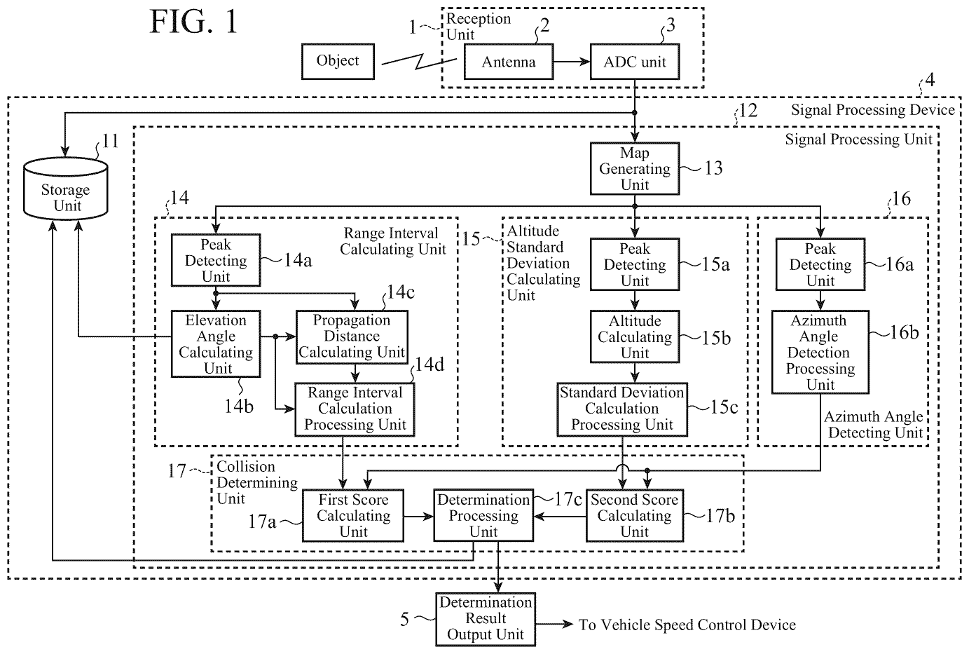

FIG. 1 is a configuration diagram illustrating a radar device according to a first embodiment.

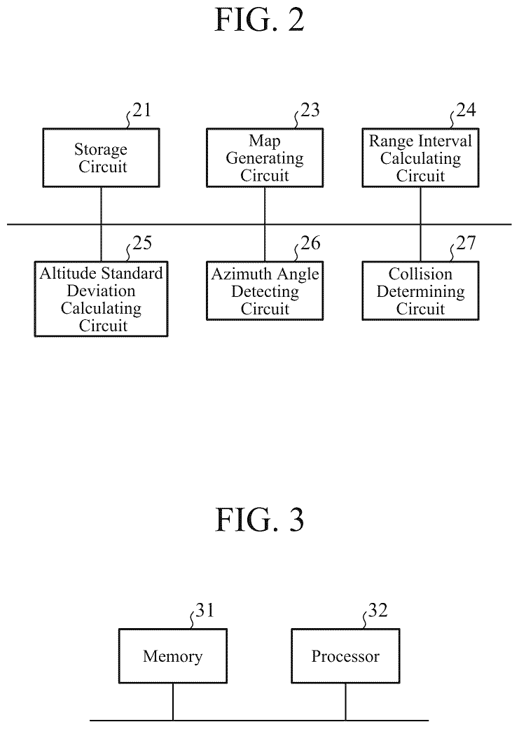

FIG. 2 is a hardware configuration diagram illustrating hardware of a signal processing device 4 according to the first embodiment.

The radar device illustrated in FIG. 1 includes a reception unit 1, the signal processing device 4, and a determination result output unit 5.

The reception unit 1 includes an antenna 2 and an analog-to-digital converting unit (hereinafter referred to as an “ADC unit”) 3.

The reception unit 1 receives a reflected wave from an object present around a mobile object. The reception unit 1 outputs reception signals of reflected waves at a plurality of times to the signal processing device 4. Examples of the mobile object include a vehicle, a train, a ship, or a human. Further, examples of the vehicle include a four-wheeled automobile, a motorcycle, a bicycle, or an electric standing two-wheeled vehicle.

In the radar device illustrated in FIG. 1, for convenience, description will be given on the assumption that the mobile object is a vehicle. However, the mobile object may be, for example, a train or a ship.

The antenna 2 receives a reflected wave from an object, and outputs a reception signal of a reflected wave to the ADC unit 3.

The ADC unit 3 acquires reception signals of reflected waves at a plurality of times from the antenna 2.

The ADC unit 3 converts a reception signal at each time from an analog signal to a digital signal at a preset sampling frequency.

The ADC unit 3 outputs the digital signal to the signal processing device 4 as a reception signal of the reflected wave.

The signal processing device 4 includes a storage unit 11 and a signal processing unit 12.

On the basis of the digital signal output from the ADC unit 3, the signal processing device 4 determines whether or not an object is present at a height at which there is a possibility of collision between a vehicle as a mobile object and the object.

The signal processing device 4 outputs a determination result to the determination result output unit 5.

Examples of the object present at a height at which there is a possibility of collision with the vehicle include another vehicle, a pedestrian, and a guardrail.

Examples of the object not present at the height at which there is a possibility of collision with the vehicle include a manhole, a grating, a sign, and a pedestrian crossing bridge.

The storage unit 11 is implemented by, for example, a storage circuit 21 illustrated in FIG. 2.

In addition to each of digital signals output from the ADC unit 3, the storage unit 11 stores a determination result and the like by the signal processing unit 12.

The signal processing unit 12 includes a map generating unit 13, a range interval calculating unit 14, an altitude standard deviation calculating unit 15, an azimuth angle detecting unit 16, and a collision determining unit 17.

The map generating unit 13 is implemented by, for example, a map generating circuit 23 illustrated in FIG. 2.

The map generating unit 13 acquires, from the reception unit 1, digital signals at a plurality of times as reception signals of reflected waves at a plurality of times.

The map generating unit 13 generates a range Doppler map (hereinafter referred to as “RD map”) indicating a signal strength level of the reception signal from the digital signal. The RD map is a two-dimensional map that indicates the signal strength level of the reception signal corresponding to a relative distance between the vehicle and the object and a relative velocity between the vehicle and the object.

The map generating unit 13 outputs the RD map to each of the range interval calculating unit 14, the altitude standard deviation calculating unit 15, and the azimuth angle detecting unit 16.

The range interval calculating unit 14 is implemented by, for example, a range interval calculating circuit 24 illustrated in FIG. 2.

The range interval calculating unit 14 includes a peak detecting unit 14a, an elevation angle calculating unit 14b, a propagation distance calculating unit 14c, and a range interval calculation processing unit 14d.

On the basis of the RD map generated by the map generating unit 13, the range interval calculating unit 14 calculates a range interval at which a direct wave from an object included in a reflected wave and a multipath wave from the object included in the reflected wave interfere with each other. As the range interval at which the direct wave and the multipath wave interfere with each other, there is a range interval at which the direct wave and the multipath wave intensify each other, or a range interval at which the direct wave and the multipath wave weaken each other.

The range interval calculating unit 14 outputs range interval information indicating the calculated range interval to the collision determining unit 17.

The peak detecting unit 14a detects a peak of the signal strength level on the basis of the RD map generated by the map generating unit 13.

Specifically, the peak detecting unit 14a detects a signal strength level larger than a threshold Th_{CFAR} related to a constant false alarm rate (CFAR) among a plurality of signal strength levels indicated in the RD map generated by the map generating unit 13 as a peak of the signal strength level. Among the plurality of signal strength levels indicated in the RD map, the relative distance related to a signal strength level larger than the threshold Th_{CFAR} is the relative distance between the vehicle and the object, and the relative velocity related to a signal strength level larger than the threshold Th_{CFAR} is the relative velocity between the vehicle and the object.

The peak detecting unit 14a outputs detection information indicating each of the relative distance related to the detected peak and the relative velocity related to the detected peak to each of the elevation angle calculating unit 14b and the propagation distance calculating unit 14c.

The elevation angle calculating unit 14b calculates a plurality of elevation angles of the object with respect to the vehicle when the direct wave and the multipath wave interfere with each other on the basis of the detection information output from the peak detecting unit 14a.

Specifically, the elevation angle calculating unit 14b calculates an eigenvalue of a correlation matrix by performing arrival direction estimation processing using a correlation matrix and an eigenvector of the reception signal on the basis of the detection information output from the peak detecting unit 14a.

The elevation angle calculating unit 14b estimates the number of waves arrived on the basis of the number of eigenvalues larger than power of thermal noise, and estimates the elevation angle of the object on the basis of the number of waves arrived. As the arrival direction estimation processing, for example, a multiple signal classification (MUSIC) method or an estimation of signal parameters via rotational invariance techniques (ESPRIT) method can be used. The MUSIC method or the ESPRIT method can be used to estimate the elevation angle of the object.

The elevation angle calculating unit 14b outputs elevation angle information indicating the calculated elevation angle to each of the propagation distance calculating unit 14c and the range interval calculation processing unit 14d.

In addition, the elevation angle calculating unit 14b may cause the elevation angle information to be stored in the storage unit 11.

The propagation distance calculating unit 14c calculates a plurality of propagation distances of the direct wave when the direct wave and the multipath wave interfere with each other on the basis of the detection information output from the peak detecting unit 14a and the elevation angle information output from the elevation angle calculating unit 14b.

The propagation distance calculating unit 14c outputs propagation distance information indicating the plurality of calculated propagation distances to the range interval calculation processing unit 14d.

The range interval calculation processing unit 14d calculates, as the range interval at which the direct wave from the object and the multipath wave from the object interfere with each other, a difference between an m-th (m is an integer of 1 or more) propagation distance and an (m+1)-th propagation distance among a plurality of propagation distances indicated by the propagation distance information output from the propagation distance calculating unit 14c. The m-th propagation distance is a propagation distance related to the m-th longest relative distance among a plurality of relative distances between the vehicle and the object when the direct wave and the multipath wave interfere with each other. The (m+1)-th propagation distance is a propagation distance related to the (m+1)-th longest relative distance among the plurality of relative distances between the vehicle and the object.

Instead of calculating the difference between the m-th propagation distance and the (m+1)-th propagation distance as the range interval at which mutual interference occurs, the range interval calculation processing unit 14d may calculate a range interval at which mutual interference occurs from an m-th elevation angle and a (m+1)-th elevation angle among a plurality of elevation angles indicated by the elevation angle information output from the elevation angle calculating unit 14b. The m-th elevation angle is an elevation angle related to the m-th longest relative distance among the plurality of relative distances between the vehicle and the object when the direct wave and the multipath wave interfere with each other. The (m+1)-th elevation angle is an elevation angle related to the (m+1)-th longest relative distance among the plurality of relative distances between the vehicle and the object.

The range interval calculation processing unit 14d outputs range interval information indicating the range interval to the collision determining unit 17.

The altitude standard deviation calculating unit 15 is implemented by, for example, an altitude standard deviation calculating circuit 25 illustrated in FIG. 2.

The altitude standard deviation calculating unit 15 includes a peak detecting unit 15a, an altitude calculating unit 15b, and a standard deviation calculation processing unit 15c.

The altitude standard deviation calculating unit 15 calculates the standard deviation of an altitude at which the object is present on the basis of the RD map generated by the map generating unit 13.

The altitude standard deviation calculating unit 15 outputs a calculation result of the standard deviation to the collision determining unit 17.

The peak detecting unit 15a detects a peak of the signal strength level on the basis of the RD map generated by the map generating unit 13, similarly to the peak detecting unit 14a.

The peak detecting unit 15a outputs detection information indicating each of the relative distance related to the detected peak and the relative velocity related to the detected peak to the altitude calculating unit 15b.

The altitude calculating unit 15b calculates an altitude at each of a plurality of times when the object is present on the basis of the detection information output from the peak detecting unit 15a.

The altitude calculating unit 15b outputs altitude information indicating the altitudes at a plurality of times to the standard deviation calculation processing unit 15c.

The standard deviation calculation processing unit 15c calculates a standard deviation of the altitude from the altitudes at the plurality of times indicated by the altitude information output from the altitude calculating unit 15b.

The standard deviation calculation processing unit 15c outputs a calculation result of the standard deviation to the collision determining unit 17.

The azimuth angle detecting unit 16 is implemented by, for example, an azimuth angle detecting circuit 26 illustrated in FIG. 2.

The azimuth angle detecting unit 16 includes a peak detecting unit 16a and an azimuth angle detection processing unit 16b.

The azimuth angle detecting unit 16 detects an azimuth angle of an object with respect to the vehicle on the basis of the RD map generated by the map generating unit 13.

The azimuth angle detecting unit 16 outputs azimuth angle detection information indicating the azimuth angle of the object to the collision determining unit 17.

The peak detecting unit 16a detects a peak of the signal strength level on the basis of the RD map generated by the map generating unit 13, similarly to the peak detecting unit 14a.

The peak detecting unit 16a outputs detection information indicating each of the relative distance related to the detected peak and the relative velocity related to the detected peak to the azimuth angle detection processing unit 16b.

In the signal processing device 4 illustrated in FIG. 1, the range interval calculating unit 14 includes the peak detecting unit 14a, the altitude standard deviation calculating unit 15 includes the peak detecting unit 15a, and the azimuth angle detecting unit 16 includes the peak detecting unit 16a. However, this is merely an example, and for example, the signal processing device 4 may include one peak detecting unit, and each of the range interval calculating unit 14, the altitude standard deviation calculating unit 15, and the azimuth angle detecting unit 16 may use detection information output from one peak detecting unit.

The azimuth angle detection processing unit 16b calculates a plurality of elevation angles of the object with respect to the vehicle when the direct wave and the multipath wave interfere with each other on the basis of the detection information output from the peak detecting unit 16a.

Specifically, the azimuth angle detection processing unit 16b calculates the eigenvalue of the correlation matrix by performing the arrival direction estimation processing using the correlation matrix and the eigenvector of the reception signal on the basis of the detection information output from the peak detecting unit 16a.

The azimuth angle detection processing unit 16b estimates the number of waves arrived on the basis of the number of eigenvalues larger than the power of the thermal noise, and estimates the azimuth angle of the object on the basis of the number of waves arrived. As the arrival direction estimation processing, for example, the MUSIC method or the ESPRIT method can be used. The azimuth angle of the object can be estimated by using the MUSIC method or the ESPRIT method.

The azimuth angle detection processing unit 16b outputs azimuth angle information indicating the azimuth angle of the object to the collision determining unit 17.

The collision determining unit 17 is implemented by, for example, a collision determining circuit 27 illustrated in FIG. 2.

The collision determining unit 17 includes a first score calculating unit 17a, a second score calculating unit 17b, and a determination processing unit 17c.

If the azimuth angle indicated by the azimuth angle information output from the azimuth angle detecting unit 16 coincides with the traveling direction of the vehicle, the collision determining unit 17 determines whether or not an object is present at a height at which there is a possibility of collision between the vehicle and the object on the basis of the range interval calculated by the range interval calculating unit 14 and the standard deviation calculated by the altitude standard deviation calculating unit 15.

The coincidence between the azimuth angle and the traveling direction of the vehicle means that a situation in which the vehicle and the object overlap on the horizontal plane occurs when the vehicle travels. On the other hand, non coincidence between the azimuth angle and the traveling direction of the vehicle means that a situation in which the vehicle and the object overlap on the horizontal plane does not occur even when the vehicle travels.

The collision determining unit 17 outputs the determination result to the determination result output unit 5.

In addition, the collision determining unit 17 may cause the determination result to be stored in the storage unit 11.

The first score calculating unit 17a determines whether or not the azimuth angle indicated by the azimuth angle information output from the azimuth angle detecting unit 16 coincides with the traveling direction of the vehicle.

When the azimuth angle coincides with the traveling direction of the vehicle, the first score calculating unit 17a calculates a first score according to the range interval calculated by the range interval calculating unit 14.

The first score calculating unit 17a outputs the first score to the determination processing unit 17c.

The second score calculating unit 17b determines whether or not the azimuth angle indicated by the azimuth angle information output from the azimuth angle detecting unit 16 coincides with the traveling direction of the vehicle.

When the azimuth angle coincides with the traveling direction of the vehicle, the second score calculating unit 17b calculates a second score according to the standard deviation calculated by the altitude standard deviation calculating unit 15.

The second score calculating unit 17b outputs the second score to the determination processing unit 17c.

The determination processing unit 17c calculates a total index value that is a sum of the first score calculated by the first score calculating unit 17a and the second score calculated by the second score calculating unit 17b.

The determination processing unit 17c determines whether or not an object is present at a height at which there is a possibility of collision between the vehicle and the object on the basis of a comparison result between the total index value and the threshold.

That is, when the total index value is larger than a first total threshold Th₁, the determination processing unit 17c determines that the object is present at a position higher than the vehicle and the object is not present at the height at which there is a possibility of collision between the vehicle and the object.

When the total index value is smaller than a second total threshold Th₂, the determination processing unit 17c determines that the object is present at a position lower than the vehicle and the object is not present at the height at which there is a possibility of collision between the vehicle and the object.

When the total index value is equal to or smaller than the first total threshold Th₁ and the total index value is equal to or larger than the second total threshold Th₂, the determination processing unit 17c determines that an object is present at a height at which there is a possibility of collision between the vehicle and the object.

The determination processing unit 17c outputs the determination result to the determination result output unit 5.

In addition, the determination processing unit 17c may cause the determination result to be stored in the storage unit 11.

Each of the first total threshold Th₁ and the second total threshold Th₂ may be stored in an internal memory of the determination processing unit 17c or may be provided from the outside of the signal processing device 4.

The determination result output unit 5 acquires the determination result output from the collision determining unit 17 of the signal processing device 4, and outputs the determination result to, for example, a vehicle speed control device, which is not illustrated. The vehicle speed control device is, for example, a device that controls the traveling speed of the vehicle, and when the determination result of the signal processing device 4 indicates that an object is present at a height at which there is a possibility of collision between the vehicle and the object, the vehicle speed control device controls the traveling speed of the vehicle in such a manner that the vehicle does not collide with the object.

In FIG. 1, it is assumed that each of the storage unit 11, the map generating unit 13, the range interval calculating unit 14, the altitude standard deviation calculating unit 15, the azimuth angle detecting unit 16, and the collision determining unit 17, which are components of the signal processing device 4, is implemented by dedicated hardware as illustrated in FIG. 2. That is, it is assumed that the signal processing device 4 is implemented by the storage circuit 21, the map generating circuit 23, the range interval calculating circuit 24, the altitude standard deviation calculating circuit 25, the azimuth angle detecting circuit 26, and the collision determining circuit 27.

Here, the storage circuit 21 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

Further, each of the map generating circuit 23, the range interval calculating circuit 24, the altitude standard deviation calculating circuit 25, the azimuth angle detecting circuit 26, and the collision determining circuit 27 corresponds to, for example, a single circuit, a composite circuit, a programmed processor, a parallel-programmed processor, an application specific integrated circuit (ASIC), a field-programmable gate array (FPGA), or a combination thereof.

The components of the signal processing device 4 are not limited to those implemented by dedicated hardware, and the signal processing device 4 may be implemented by software, firmware, or a combination of software and firmware.

The software or firmware is stored in a memory of the computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

FIG. 3 is a hardware configuration diagram of a computer in a case where the signal processing device 4 is implemented by software, firmware, or the like.

In a case where the signal processing device 4 is implemented by software, firmware, or the like, the storage unit 11 is configured on the memory 31 of the computer. A program for causing a computer to execute processing procedures in the map generating unit 13, the range interval calculating unit 14, the altitude standard deviation calculating unit 15, the azimuth angle detecting unit 16, and the collision determining unit 17 is stored in the memory 31. Then, the processor 32 of the computer executes the program stored in the memory 31.

Further, FIG. 2 illustrates an example in which each of the components of the signal processing device 4 is implemented by dedicated hardware, and FIG. 3 illustrates an example in which the signal processing device 4 is implemented by software, firmware, or the like. However, this is merely an example, and some components in the signal processing device 4 may be implemented by dedicated hardware, and the remaining components may be implemented by software, firmware, or the like.

Next, the operation of the radar device illustrated in FIG. 1 will be described.

A transmission unit, not illustrated, included in the radar device emits radio waves toward an object present around the vehicle. The transmission unit that emits radio waves toward an object may be a device outside the radar device.

The radio wave radiation method may be any method, and for example, a frequency modulation continuous wave (FMCW) method, a frequency modulated and interrupted continuous wave (FMICW) method, or a pulse Doppler method can be used as the radio wave radiation method.

The antenna 2 of the reception unit 1 receives a reflected wave from an object present around the vehicle.

The antenna 2 outputs reception signals r(t) of the reflected waves at a plurality of times t to the ADC unit 3.

The ADC unit 3 acquires the reception signals r(t) of the reflected waves at the plurality of times t from the antenna 2.

The ADC unit 3 converts the reception signal r(t) at each time t from an analog signal to a digital signal r_{D}(t) at a preset sampling frequency.

The ADC unit 3 outputs the digital signal r_{D}(t) to the signal processing device 4 as a reception signal of the reflected wave.

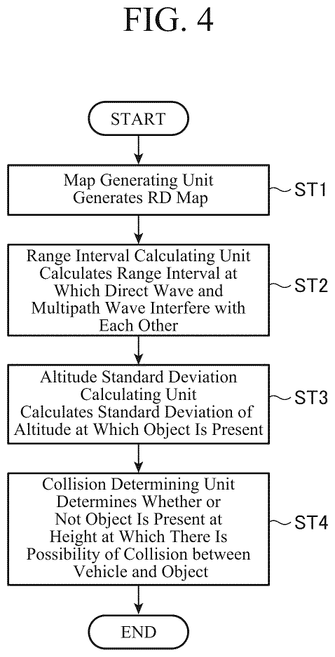

FIG. 4 is a flowchart illustrating a signal processing method that is a processing procedure of the signal processing device 4.

The digital signal r_{D}(t) output from the ADC unit 3 is stored in the storage unit 11 and provided to the map generating unit 13.

The map generating unit 13 acquires the digital signal ID (t) from the reception unit 1 as the reception signal of the reflected wave at the time t.

The map generating unit 13 generates the RD map indicating the signal strength level of the reception signal by performing Fourier transform on the digital signal r_{D}(t) in a range direction and a Doppler velocity direction (step ST1 in FIG. 4).

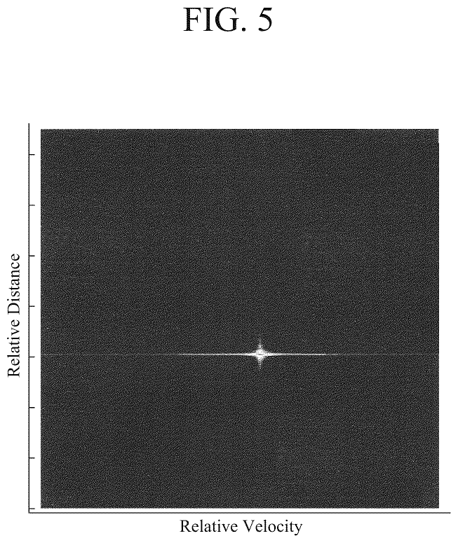

FIG. 5 is an explanatory diagram illustrating an example of the RD map generated by the map generating unit 13.

In FIG. 5, the horizontal axis represents a Doppler velocity which is a relative velocity between the vehicle and the object, and the vertical axis represents a relative distance between the vehicle and the object. The RD map is a two-dimensional map illustrating the signal strength level SL of the reception signal at the relative distance and the relative velocity. In FIG. 5, the difference in shading represents the difference in signal strength level. The RD map illustrated in FIG. 5 indicates that one object is present around the vehicle.

The relative velocity of the RD map illustrated in FIG. 5 is divided into, for example, V, and the relative distance of the RD map is divided into, for example, L. Each of V and L is an integer of 1 or more.

The map generating unit 13 outputs the RD map to each of the range interval calculating unit 14, the altitude standard deviation calculating unit 15, and the azimuth angle detecting unit 16.

Here, the positional relationship between the vehicle and the object will be described. Further, a relationship between the direct wave included in the reflected wave from the object and the multipath wave included in the reflected wave will be described.

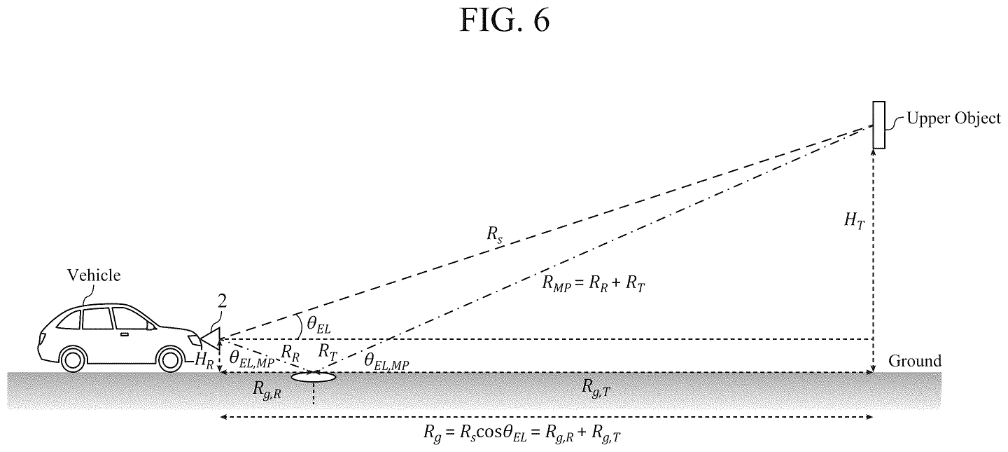

FIG. 6 is an explanatory diagram illustrating a positional relationship between the vehicle and an upper object and a reflected wave from the upper object. The upper object is an object present at a position higher than the vehicle and is an object not present at a height at which there is a possibility of collision with the vehicle.

In the example of FIG. 6, the antenna 2 is provided at a position where the altitude from the ground is HR, and the upper object is present at a position where the altitude from the ground is HT.

The example of FIG. 6 illustrates a situation in which the antenna 2 simultaneously receives both a direct wave and a multipath wave. However, only the multipath wave specularly reflected by the ground is illustrated for simplification of description. The reflection position of the multipath wave on the ground is a position where the ground distance from the antenna 2 is R_{g,R} and a position where the ground distance from the upper object is R_{g,T}. The ground distance from the antenna 2 to the upper object is R_{g}=R_{g,R}+R_{g,T}. Hereinafter, the ground distance is referred to as a ground range.

The elevation angle of the upper object with respect to the vehicle is θ_{EL}, and each of the incident angle of the multipath wave with respect to the ground and the reflection angle of the multipath wave with respect to the ground is θ_{EL,MP}.

The reception signal s of the antenna 2 when the direct wave and the multipath wave are superimposed on each other is expressed by the following Expression (1).

$$s = exp ( - j 2 π {f}_{0} \frac{{R}_{s}}{c} ) + {K}_{MP} exp ( - j 2 π {f}_{0} \frac{{R}_{MP}}{c} ) \qquad ( 1 )$$

In Expression (1), f₀ is a center frequency of a radio wave radiated from a transmission unit, not illustrated, included in the radar device, and c is a speed of light.

R_{S} is a propagation distance of the direct wave, R_{MP} is a propagation distance of the multipath wave, and K_{MP} is a reflection coefficient of the multipath wave.

The propagation distance R_{MP} of the multipath wave is expressed by the following Expression (2).

$${R}_{MP} = {R}_{R} + {R}_{T} \qquad ( 2 )$$

In Expression (2), R_{T} is a propagation distance from the upper object to the ground, and R_{R} is the propagation distance from the ground to the antenna 2.

The ground range R_{g} between the antenna 2 and the upper object is expressed by the following Expression (3) from a geometrical relationship.

$${R}_{g} = {R}_{s} cos {θ}_{EL} = {R}_{g , R} + {R}_{g , T} \qquad ( 3 )$$

The elevation angle θ_{EL} of the upper object with respect to the vehicle is expressed by the following Expression (4), and each of the incident angle θ_{EL,MP} of the multipath wave and the reflection angle θ_{EL,MP} of the multipath wave is expressed by the following Expression (5).

$$sin {θ}_{EL} = \frac{{H}_{T} - {H}_{R}}{{R}_{s}} \qquad ( 4 )$$

$$tan {θ}_{EL , MP} = \frac{{H}_{R}}{{R}_{g , R}} = \frac{{H}_{T}}{{R}_{g , T}} \qquad ( 5 )$$

When the direct wave and the multipath wave interfere with each other due to the superposition of the direct wave and the multipath wave, the following Expression (6) holds.

$${R}_{s} - {R}_{MP} = m λ \qquad ( 6 )$$

In Expression (6), m is an integer, and m=0, ±1, ±2, . . . , ±M.

By transforming Expression (4), the propagation distance R_{S} of the direct wave is expressed as the following Expression (7).

Further, Expression (5) can be transformed as the following Expression (8), and Expression (8) can be transformed as the following Expression (9). Therefore, the propagation distance R_{MP} of the multipath wave illustrated in Expression (2) can be transformed as in the following Expression (10).

$${R}_{s} = \frac{{H}_{T} - {H}_{R}}{sin {θ}_{EL}} \qquad ( 7 )$$

$$tan {θ}_{EL , MP} = \frac{{H}_{T}}{{R}_{g , T}} = \frac{{H}_{R} + {H}_{T}}{{R}_{g}} \qquad ( 8 )$$

$$sin {θ}_{EL , MP} = sin ( arctan ( \frac{{H}_{R} + {H}_{T}}{{R}_{g}} ) ) \qquad ( 9 )$$

$${R}_{MP} = {R}_{R} + {R}_{T} = \frac{{H}_{T} + {H}_{R}}{sin {θ}_{EL , MP}} \qquad ( 10 )$$

By substituting each of Expressions (7) and (10) into Expression (6), sin θ_{EL,m} in a case where the direct wave and the multipath wave interfere with each other is expressed as the following Expression (11). Therefore, the elevation angle θ_{EL,m} when the direct wave and the multipath wave interfere with each other is expressed by the following Expression (12).

$$sin {θ}_{EL , m} = \frac{{H}_{T} - {H}_{R}}{{H}_{T} + {H}_{R} + m λ sin {θ}_{EL , MP}} \qquad ( 11 )$$

$${θ}_{EL , m} = arc sin ( \frac{{H}_{T} - {H}_{R}}{{H}_{T} + {H}_{R} + m λ sin {θ}_{EL , MP}} ) = arc sin ( \frac{{H}_{T} - {H}_{R}}{{H}_{T} + {H}_{R} + m λ sin ( arc tan ( \frac{{H}_{R} - {H}_{T}}{{R}_{g}} ) )} ) \qquad ( 12 )$$

By using the elevation angle θ_{EL,m} in a case where the direct wave and the multipath wave interfere with each other, the propagation distance R_{S,m} of the direct wave in a case where the direct wave and the multipath wave interfere with each other is expressed as the following Expression (13).

Further, by using the elevation angle θ_{EL,m}, the ground range R_{g,m} between the antenna 2 and the upper object when the direct wave and the multipath wave interfere with each other is expressed as the following Expression (14).

$${R}_{s , m} = \frac{{H}_{T} - {H}_{R}}{sin {θ}_{EL , m}} \qquad ( 13 )$$

$${R}_{g , m} = \frac{{H}_{T} - {H}_{R}}{tan {θ}_{EL , m}} \qquad ( 14 )$$

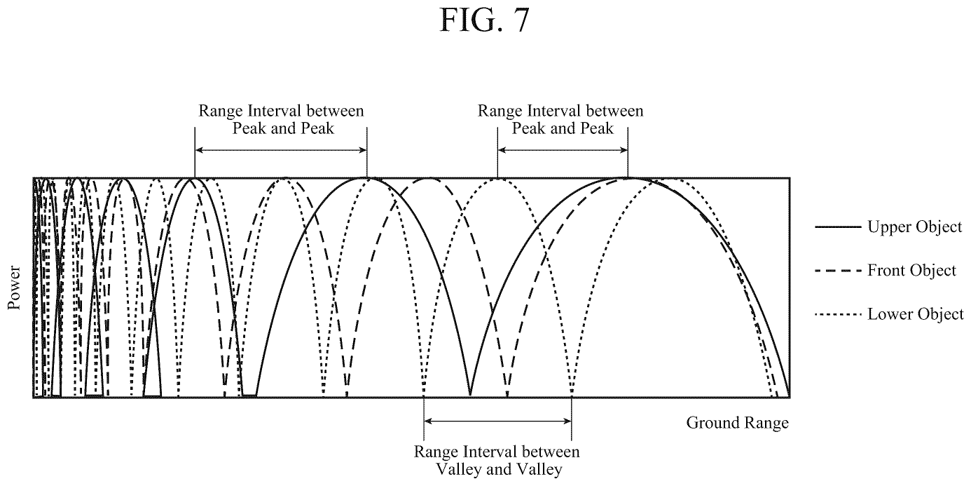

FIG. 7 is an explanatory diagram illustrating the relationship between the ground range in a case where the object is an upper object, a front object, or a lower object and the power of the reception signal s in a case where the direct wave and the multipath wave are superimposed.

The front object is an object present at a height at which there is a possibility of collision with the vehicle. The lower object is an object that is present at a position lower than the vehicle, and is an object that is not present at a height at which there is a possibility of collision with the vehicle.

In FIG. 7, a solid line indicates the power of the reception signal s corresponding to the ground range related to the upper object, and a broken line indicates the power of the reception signal s corresponding to the ground range related to the front object. A dotted line indicates the power of the reception signal s corresponding to the ground range related to the lower object.

A peak point of the power of the reception signal s is called a peak, and a null point of the power of the reception signal s is called a valley.

The range interval between peaks is a range interval when the direct wave and the multipath wave intensify each other. The range interval between valleys is a range interval when the direct wave and the multipath wave weaken each other. In the range interval between a point near a peak and a point near the peak, the direct wave and the multipath wave moderately intensify each other, but in the present specification, the range interval between the peak and the peak is assumed to be a range interval when the direct wave and the multipath wave intensify each other. Further, in the range interval between a point near a valley and a point near the valley, the direct wave and the multipath wave moderately weaken each other, but in the present specification, the range interval between the valley and the valley is assumed to be a range interval when the direct wave and the multipath wave weaken each other.

As illustrated in FIG. 7, the range interval between the peak and the peak is longer as the altitude at which the object is present is higher. Further, as illustrated in FIG. 7, the shorter the ground range between the antenna 2 and the object, the shorter the range interval between the peaks.

The range interval between the valleys is also longer as the altitude at which the object is present is higher, and is shorter as the ground range between the antenna 2 and the object is shorter.

The ground range R_{g,m} (m=0, ±1, ±2, . . . , ±M) when the direct wave and the multipath wave interfere with each other can be obtained on the basis of increase or decrease of the power of the reception signal s.

The range interval ΔRₘ when the direct wave and the multipath wave interfere with each other can be calculated from the elevation angle θ_{EL,m} related to the m-th ground range R_{g,m} and the elevation angle θ_{EL}, m+1 related to the (m+1)-th ground range R_{g,m+1} as expressed in the following Expression (15).

$$Δ {R}_{m} = {R}_{s , m + 1} - {R}_{s , m} = ( {H}_{T , m} - {H}_{R} ) ( \frac{1}{sin {θ}_{EL , m + 1}} - \frac{1}{sin {θ}_{EL , m}} ) \qquad ( 15 )$$

The range interval calculating unit 14 acquires the RD map from the map generating unit 13.

The range interval calculating unit 14 calculates an intensifying range interval ΔRₘ or a weakening range interval ΔRₘ as a range interval at which the direct wave included in the reflected wave and the multipath wave included in the reflected wave interfere with each other on the basis of the RD map (step ST2 in FIG. 4).

The range interval calculating unit 14 outputs range interval information indicating the range interval ΔRₘ to the collision determining unit 17.

Hereinafter, the calculation processing of the range interval ΔRₘ by the range interval calculating unit 14 will be specifically described.

Among V×L signal strength levels SL_{1,1} to SL_{V,L} indicated in the RD map, the peak detecting unit 14a detects a signal strength level SL_{v,1} larger than the threshold Th_{CFAR} related to CFAR as a peak SL_{peak,m} of the signal strength level.

Among the V×L signal strength levels SL_{1,1} to SL_{V,L}, a signal strength level SL_{v,1} larger than the threshold Th_{CFAR} represents a signal strength level related to a reflected wave by an object present around the vehicle.

The peak detecting unit 14a outputs detection information indicating each of a relative velocity v related to the peak SL_{peak,m} and a relative distance 1 related to the peak SL_{peak,m} to each of the elevation angle calculating unit 14b and the propagation distance calculating unit 14c.

The elevation angle calculating unit 14b acquires the detection information from the peak detecting unit 14a.

The elevation angle calculating unit 14b calculates an elevation angle θ_{EL,m} (m=0, ±1, ±2, . . . , ±M) when the direct wave and the multipath wave interfere with each other on the basis of the detection information.

Specifically, the elevation angle calculating unit 14b calculates the eigenvalue of the correlation matrix by performing the arrival direction estimation processing using the correlation matrix and the eigenvector of the reception signal s on the basis of the detection information.

The elevation angle calculating unit 14b estimates the number of waves arrived on the basis of the number of eigenvalues larger than the power of the thermal noise, and calculates the elevation angle θ_{EL,m} (m=0, ±1, ±2, . . . , ±M) on the basis of the number of waves arrived.

The elevation angle calculating unit 14b outputs elevation angle information indicating the elevation angle θ_{EL,m} (m=0, ±1, ±2, . . . , ±M) to each of the propagation distance calculating unit 14c and the range interval calculation processing unit 14d.

The propagation distance calculating unit 14c acquires the detection information from the peak detecting unit 14a and acquires the elevation angle information from the elevation angle calculating unit 14b.

The propagation distance calculating unit 14c calculates the altitude H_{T,m} of the object by substituting the relative distance 1 related to the peak SL_{peak,m} indicated by the detection information into the following Expression (16) as the propagation distance R_{S,m} (m=0, ±1, ±2, . . . , ±M) of the direct wave, and substituting the elevation angle θ_{EL,m} indicated by the elevation angle information into Expression (16). The altitude HR at which the antenna 2 is installed is stored in an internal memory of the propagation distance calculating unit 14c, for example. In the multipath environment, the elevation angle θ_{EL,m} may include an error, and thus the altitude H_{T,m} of the object may include an error.

$${H}_{T , m} = {R}_{S , m} \times sin ( {θ}_{EL , m} ) + {H}_{R} \qquad ( 16 )$$

The propagation distance calculating unit 14c substitutes the altitude H_{T,m} of the object as H_{T} in Expression (7), substitutes the elevation angle θ_{EL,m} as θ_{EL} in Expression (7), and substitutes the altitude H_{R} at which the antenna 2 is installed in Expression (7), thereby calculating a plurality of propagation distances of the direct wave when the direct wave and the multipath wave interfere with each other. The propagation distance calculating unit 14c outputs the propagation distance information indicating the propagation distance R_{S,m} to the range interval calculation processing unit 14d.

The range interval calculation processing unit 14d acquires the elevation angle information from the elevation angle calculating unit 14b, and acquires the propagation distance information from the propagation distance calculating unit 14c.

The range interval calculation processing unit 14d specifies the propagation distance R_{S,m} related to the m-th ground range R_{g,m} and the propagation distance R_{S,m+1} related to the (m+1)-th ground range R_{g,m+1} among the plurality of propagation distances R_{S,0} to R_{S,M} indicated by the propagation distance information.

The range interval calculation processing unit 14d calculates a range interval ΔR_{,m} when the direct wave and the multipath wave interfere with each other by substituting the m-th propagation distance R_{S,m} and the (m+1)-th propagation distance R_{S,m+1} into Expression (15).

The range interval calculation processing unit 14d outputs range interval information indicating the range interval ΔRₘ to the collision determining unit 17.

Here, the range interval calculation processing unit 14d calculates the range interval ΔRₘ from the m-th propagation distance R_{S,m} and the (m+1)-th propagation distance R_{S,m+1}. However, this is merely an example, and the range interval calculation processing unit 14d may calculate the range interval ΔRₘ from the elevation angle θ_{EL,m} related to the m-th ground range R_{g,m} and the elevation angle θ_{EL,m+1} related to the (m+1)-th ground range R_{g,m+1}.

That is, the range interval calculation processing unit 14d specifies the m-th elevation angle θ_{EL,m} and the (m+1)-th elevation angle θ_{EL,m+1} among the plurality of elevation angles θ_{EL,1} to θ_{EL,M} indicated by the elevation angle information.

The range interval calculation processing unit 14d calculates the range interval ΔRₘ when the direct wave and the multipath wave interfere with each other by substituting each of the m-th elevation angle θ_{EL,m}, the (m+1)-th elevation angle θ_{EL,m+1}, the altitude H_{T,m}, and the altitude H_{R} into Expression (15).

The altitude standard deviation calculating unit 15 acquires the RD map from the map generating unit 13.

The altitude standard deviation calculating unit 15 calculates the standard deviation H_{std} of the altitude at which the object is present on the basis of the RD map (step ST3 in FIG. 4).

The altitude standard deviation calculating unit 15 outputs the calculation result of the standard deviation H_{std} to the collision determining unit 17.

Hereinafter, the calculation processing of the standard deviation H_{std} by the altitude standard deviation calculating unit 15 will be specifically described.

The peak detecting unit 15a detects the peak SL_{peak,m} of the signal strength level on the basis of the RD map generated by the map generating unit 13, similarly to the peak detecting unit 14a.

The peak detecting unit 15a outputs detection information indicating each of the relative distance related to the detected peak SL_{peak,m} and the relative velocity related to the detected peak SL_{peak,m} to the altitude calculating unit 15b.

The altitude calculating unit 15b acquires detection information from the peak detecting unit 15a.

The altitude calculating unit 15b calculates the propagation distance R_{S,m} (m=0, ±1, ±2, . . . , ±M) of the direct wave when the direct wave and the multipath wave interfere with each other on the basis of the detection information, similarly to the propagation distance calculating unit 14c.

Further, the altitude calculating unit 15b calculates the elevation angle θ_{EL,m} (m=0, ±1, ±2, . . . , ±M) when the direct wave and the multipath wave interfere with each other on the basis of the detection information, similarly to the elevation angle calculating unit 14b.

The altitude calculating unit 15b calculates the altitude H_{T,m} (m=0, ±1, ±2, . . . , ±M) at a plurality of times by substituting the propagation distance R_{S,m}, the elevation angle θ_{EL,m}, and the altitude H_{R} into Expression (16). The altitude H_{R} is stored in an internal memory of the altitude calculating unit 15b, for example.

The altitude calculating unit 15b outputs the calculation result of the altitude H_{T,m} to the standard deviation calculation processing unit 15c.

The standard deviation calculation processing unit 15c acquires the calculation result of the altitude H_{T,m} from the altitude calculating unit 15b.

The standard deviation calculation processing unit 15c calculates the standard deviation H_{std} of the altitude from the altitudes H_{T,1} to H_{T,M} at a plurality of times as expressed in the following Expression (17).

The standard deviation calculation processing unit 15c outputs the calculation result of the standard deviation H_{std} to the collision determining unit 17.

$${H}_{std} = std ( {H}_{T , 1} , {H}_{T , 2} , ⋯ , {H}_{T , M} ) \qquad ( 17 )$$

In Expression (17), std( ) is a function for calculating the standard deviation of the altitudes H_{T,1} to H_{T,M} in parentheses.

The azimuth angle detecting unit 16 acquires the RD map from the map generating unit 13.

The azimuth angle detecting unit 16 detects an azimuth angle of an object with respect to the vehicle on the basis of the RD map.

The azimuth angle detecting unit 16 outputs azimuth angle detection information indicating the azimuth angle of the object to the collision determining unit 17.

Hereinafter, azimuth angle detection processing by the azimuth angle detecting unit 16 will be specifically described.

The peak detecting unit 16a detects the peak SL_{peak,m} of the signal strength level on the basis of the RD map generated by the map generating unit 13, similarly to the peak detecting unit 14a.

The peak detecting unit 16a outputs detection information indicating each of the relative distance related to the detected peak SL_{peak,m} and the relative velocity related to the detected peak SL_{peak,m} to the azimuth angle detection processing unit 16b.

The azimuth angle detection processing unit 16b acquires detection information from the peak detecting unit 16a.

The azimuth angle detection processing unit 16b calculates a plurality of azimuth angles of the object with respect to the vehicle when the direct wave and the multipath wave interfere with each other on the basis of the detection information.

Specifically, the azimuth angle detection processing unit 16b calculates the eigenvalue of the correlation matrix by performing the arrival direction estimation processing using the correlation matrix and the eigenvector of the reception signal s on the basis of the detection information output from the peak detecting unit 16a.

The azimuth angle detection processing unit 16b estimates the number of waves arrived on the basis of the number of eigenvalues larger than the power of the thermal noise, and estimates the azimuth angle of the object on the basis of the number of waves arrived.

The azimuth angle detection processing unit 16b outputs the azimuth angle information indicating the azimuth angle of the object to the collision determining unit 17.

The collision determining unit 17 acquires the range interval ΔRₘ from the range interval calculating unit 14, acquires the standard deviation H_{std} of the altitude from the altitude standard deviation calculating unit 15, and acquires the azimuth angle information from the azimuth angle detecting unit 16.

If the azimuth angle indicated by the azimuth angle information coincides with the traveling direction of the vehicle, the collision determining unit 17 determines whether or not the object is present at a height at which there is a possibility of collision between the vehicle and the object on the basis of the range interval ΔRₘ and the standard deviation H_{std} of the altitude (step ST4 in FIG. 4).

The collision determining unit 17 outputs the determination result to the determination result output unit 5.

Hereinafter, the determination processing by the collision determining unit 17 will be specifically described.

The first score calculating unit 17a determines whether or not the azimuth angle indicated by the azimuth angle information coincides with the traveling direction of the vehicle.

When the azimuth angle coincides with the traveling direction of the vehicle, the first score calculating unit 17a sets a first threshold Th_{UP,r} indicating the boundary between the upper object and the front object and a second threshold Th_{DW,r} indicating the boundary between the front object and the lower object for each ground range r. r is an integer equal to or more than 1.

Hereinafter, threshold setting processing by the first score calculating unit 17a will be specifically described.

As illustrated in FIG. 7, the range interval between the peaks, which is the range interval ΔRₘ when the direct wave and the multipath wave intensify each other, is longer as the altitude at which the object is present is higher. Further, as illustrated in FIG. 7, the shorter the ground range between the antenna 2 and the object, the shorter the range interval between the peaks.

Thus, each of the first threshold Th_{UP,r} and the second threshold Th_{DW,r} for the short ground range r is set to a small value. On the other hand, each of the first threshold Th_{UP,r} and the second threshold Th_{DW,r} for the long ground range r is set to a large value.

For example, an internal memory of the first score calculating unit 17a stores a range interval ΔR_{FRO,r} for each ground ranger when an object present around the vehicle is the front object as expressed in the following Expression (18).

For example, the altitude H_{T,FRO} of the front object is lower than the altitude H_{Cel} of the ceiling of the vehicle. For example, the altitude H_{T,FRO} of the front object is higher than a minimum ground altitude H_{FLO} of the vehicle. H_{FLO}<H_{Cel} holds.

$$Δ {R}_{FRO , r} = {R}_{s , m + 1} - {R}_{s , m} = ( {H}_{T , FRO} - {H}_{R} ) ( \frac{1}{sin {θ}_{EL , m + 1}} - \frac{1}{sin {θ}_{EL , m}} ) \qquad ( 18 )$$

The first score calculating unit 17a sets the first threshold Th_{UP,r} indicating the boundary between the upper object and the front object for each ground range r using the range interval ΔR_{FRO,r} for each ground range r as expressed in the following Expression (19).

Further, the first score calculating unit 17a sets the second threshold Th_{DW,r} indicating the boundary between the front object and the lower object for each ground range r using the range interval ΔR_{FRO,r} for each ground range r as expressed in the following Expression (20).

$${Th}_{UP , r} = {P}_{1} \times Δ {R}_{FRO , r} \qquad ( 19 )$$

$${Th}_{DW , r} = {P}_{2} \times Δ {R}_{FRO , r} \qquad ( 20 )$$

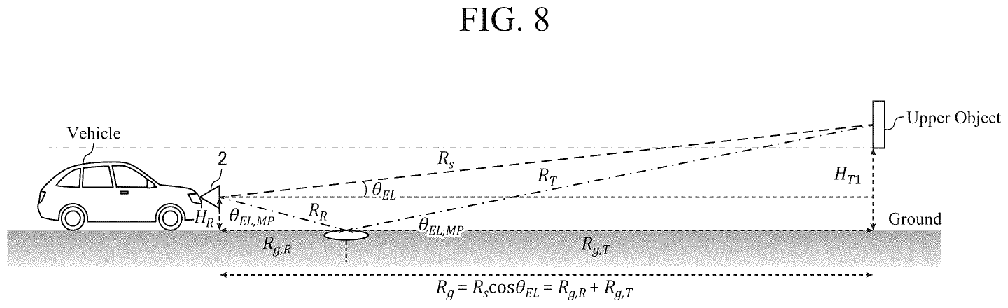

In Expression (19), P₁ is a coefficient larger than 1, and is a coefficient for making the first threshold Th_{UP,r} larger than the range interval ΔR_{FRO,r} related to the front object. The altitude corresponding to the range interval ΔR_{FRO,r} is desirably higher than the altitude H_{Cel} of the ceiling of the vehicle and as close to the altitude H_{Cel} as possible. Thus, the first threshold Th_{UP,r} is set to a range interval corresponding to the altitude H_{T1} slightly higher than the altitude H_{Cel}, for example, as illustrated in FIG. 8. FIG. 8 is an explanatory diagram illustrating a setting example of the first threshold Th_{UP,r}.

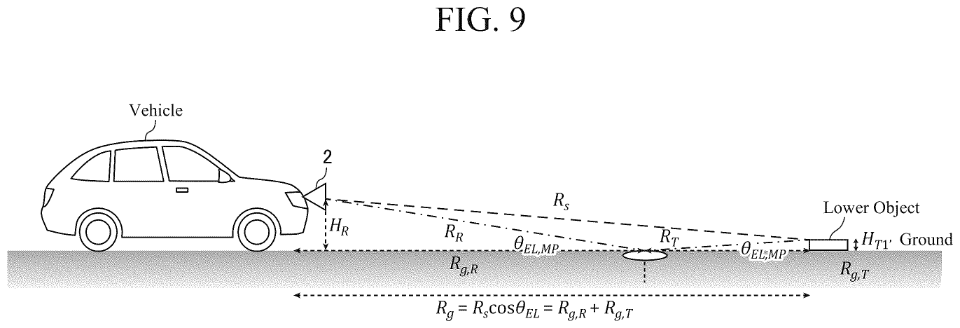

In Expression (20), P₂ is a coefficient smaller than 1, and is a coefficient for making the second threshold Th_{DW,r} smaller than the range interval ΔR_{FRO,r} related to the front object. The altitude corresponding to the range interval ΔR_{FRO,r} is desirably lower than the minimum ground altitude H_{FLO} of the vehicle and as close to the minimum ground altitude H_{FLO} as possible. Thus, the second threshold Th_{DW,r} is set to a range interval corresponding to the altitude H_{T1}′ slightly lower than the minimum ground altitude H_{FLO}, for example, as illustrated in FIG. 9. FIG. 9 is an explanatory diagram illustrating an example of setting the second threshold Th_{DW,r}.

The first score calculating unit 17a acquires the range interval ΔRₘ (m=0, ±1, ±2, . . . , ±M) from the range interval calculating unit 14.

The first score calculating unit 17a specifies a range interval ΔRᵣ corresponding to the ground range r among the range intervals ΔR₀ to ΔR_{M}. For example, when the peak having the shorter ground range among the two peaks indicating the range interval ΔRₘ of m=5 belongs to the ground range of “3”, the first score calculating unit 17a sets the range interval ΔRₘ of m=5 to the range interval ΔRᵣ of r=3.

After setting the first threshold Th_{UP,r} and the second threshold Th_{DW,r}, the first score calculating unit 17a compares the range interval ΔRᵣ with the first threshold Th_{UP,r} and compares the range interval ΔRᵣ with the second threshold Th_{DW,r} for each ground range r.

When the range interval ΔRᵣ is larger than the first threshold Th_{UP,r}, the first score calculating unit 17a sets the value of the first score to a first value.

When the range interval ΔRᵣ is equal to or smaller than the first threshold Th_{UP,r} and the range interval ΔRᵣ is equal to or larger than the second threshold Th_{DW,r}, the first score calculating unit 17a sets the value of the first score to a second value.

When the range interval ΔRᵣ is smaller than the second threshold Th_{DW,r}, the first score calculating unit 17a sets the value of the first score to a third value. The first value>the second value>the third value holds.

The first score calculating unit 17a outputs the first score to the determination processing unit 17c.

Here, the first score calculating unit 17a sets the first score according to the comparison result between the range interval ΔRᵣ and each of the first threshold Th_{UP,r} and the second threshold Th_{DW,r}. However, this is merely an example, and the first score calculating unit 17a may obtain a larger first score as the range interval ΔRᵣ is larger by substituting the range interval ΔRᵣ into a multi-functional expression for calculating the first score.

The second score calculating unit 17b determines whether or not the azimuth angle indicated by the azimuth angle information coincides with the traveling direction of the vehicle.

When the azimuth angle coincides with the traveling direction of the vehicle, the second score calculating unit 17b sets a third threshold Th_{UP′,r} indicating the boundary between the upper object and the front object and a fourth threshold Th_{DW′,r} indicating the boundary between the front object and the lower object for each ground range r.

Hereinafter, threshold setting processing by the second score calculating unit 17b will be specifically described.

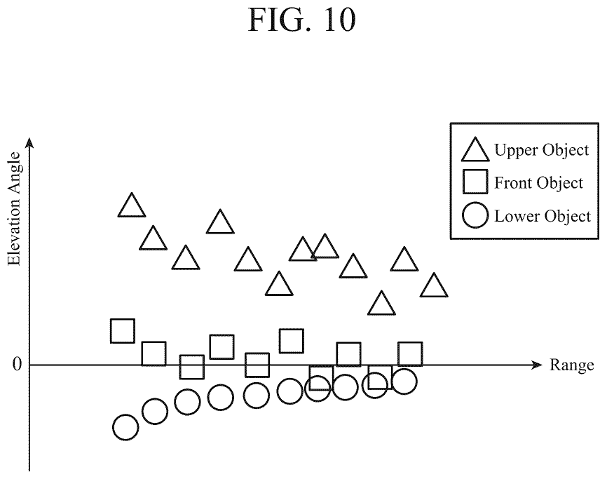

FIG. 10 is an explanatory diagram illustrating an example of angle measurement values of elevation angles of an upper object, a front object, and a lower object which are objects.

In FIG. 10, the horizontal axis represents the relative distance between the vehicle and the object, and the vertical axis represents the elevation angle of the object.

Δ is a measured angle value of the elevation angle of the upper object, □ is a measured angle value of the elevation angle of the front object, and ◯ is a measured angle value of the elevation angle of the lower object.

As can be seen from FIG. 10, as the altitude of the object is higher, the angle measurement accuracy of the elevation angle is more likely to deteriorate due to the influence of the multipath wave.

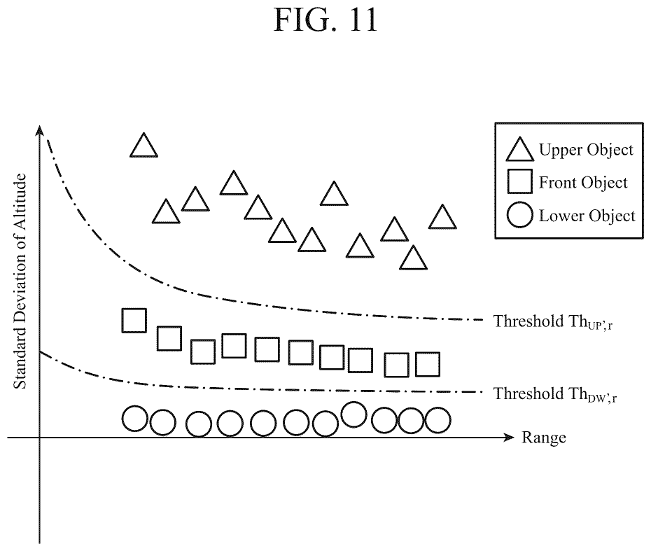

FIG. 11 is an explanatory diagram illustrating an example of standard deviations of altitudes of an upper object, a front object, and a lower object which are objects.

In FIG. 11, the horizontal axis represents the relative distance between the vehicle and the object, and the vertical axis represents the standard deviation of the altitude of the object.

Δ is a standard deviation of the altitude of the upper object, □ is a standard deviation of the altitude of the front object, and ◯ is a standard deviation of the altitude of the lower object.

As can be seen from FIG. 11, the standard deviation of the altitude of the object is more likely to deteriorate due to the influence of the multipath wave as the altitude of the object is higher, similarly to the measured angle value of the elevation angle. Thus, the standard deviation of the altitude of the upper object is larger than the standard deviation of the altitude of the front object. Further, the standard deviation of the altitude of the front object is larger than the standard deviation of the altitude of the lower object.

In the example of FIG. 11, the third threshold Th_{UP′,r} is set between the standard deviation of the altitude of the upper object and the standard deviation of the altitude of the front object for each ground range r. Further, the fourth threshold Th_{DW′,r} is set between the standard deviation of the altitude of the front object and the standard deviation of the altitude of the lower object for each ground range r.

Each of the third threshold Th_{UP′,r} and the fourth threshold Th_{DW′,r} is desirably close to the standard deviation of the altitude of the front object as much as possible.

For example, an internal memory of the second score calculating unit 17b stores a standard deviation H_{FROstd,r} of the altitude for each ground range r when an object present around the vehicle is the front object.

The second score calculating unit 17b sets the third threshold Th_{UP′,r} indicating the boundary between the upper object and the front object for each ground range r using the standard deviation H_{FROstd,r} of the altitude for each ground range r as expressed in the following Expression (21).

Further, the second score calculating unit 17b sets the fourth threshold Th_{DW′,r} indicating the boundary between the front object and the lower object for each ground range r using the standard deviation H_{FROstd,r} of the altitude for each ground range r as expressed in the following Expression (22).

$${Th}_{{UP}^{′} , r} = {P}_{3} \times {H}_{FROstd , r} \qquad ( 21 )$$

$${Th}_{{DW}^{′} , r} = {P}_{4} \times {H}_{FROstd , r} \qquad ( 22 )$$

In Expression (21), P₃ is a coefficient larger than 1, and is a coefficient for making the third threshold Th_{UP′,r} larger than the standard deviation H_{FROstd,r} of the altitude related to the front object. The third threshold Th_{UP′,r} is desirably higher than the altitude H_{Cel} of the ceiling of the vehicle and as close to the altitude H_{Cel} as possible.

In Expression (22), P₄ is a coefficient smaller than 1, and is a coefficient for making the fourth threshold Th_{DW′,r} smaller than the standard deviation H_{FROstd,r} of the altitude related to the front object. The fourth threshold Th_{DW′,r} is desirably lower than the minimum ground altitude H_{FLO} of the vehicle and as close to the minimum ground altitude H_{FLO} as possible.

The second score calculating unit 17b acquires the calculation result of the standard deviation H_{std} of the altitude from the altitude standard deviation calculating unit 15.

The second score calculating unit 17b specifies the ground range r corresponding to the standard deviation H_{std} of the altitude, and sets the standard deviation H_{std} as the standard deviation H_{FROstd,r} of the ground range r.

For example, if the ground range of the standard deviation H_{std} of the altitude corresponds to the ground range of r=7, the standard deviation H_{std} is set as the standard deviation H_{FROstd,7}. If the ground range of the standard deviation H_{std} of the altitude corresponds to the ground range of r=8, the standard deviation H_{std} is set as the standard deviation H_{FROstd,8}.

After setting the third threshold Th_{UP′,r} and the fourth threshold Th_{DW′,r}, the second score calculating unit 17b compares the standard deviation H_{FROstd,r} of the altitude and the third threshold Th_{UP′,r} and compares the standard deviation H_{FROstd,r} of the altitude and the fourth threshold Th_{DW′,r} for each ground range r.

When the standard deviation H_{FROstd,r} of the altitude is larger than the third threshold Th_{UP′,r}, the second score calculating unit 17b sets the value of the second score to a fourth value.

The second score calculating unit 17b sets the value of the second score to a fifth value when the standard deviation H_{FROstd,r} of the altitude is equal to or smaller than the third threshold Th_{UP′,r} and the standard deviation H_{FROstd,r} of the altitude is equal to or larger than the fourth threshold Th_{DW′,r}.

When the standard deviation H_{FROstd,r} of the altitude is smaller than the fourth threshold Th_{DW′,r}, the second score calculating unit 17b sets the value of the second score to a sixth value. The fourth value>the fifth value>the sixth value holds.

The second score calculating unit 17b outputs the second score to the determination processing unit 17c.

Here, the second score calculating unit 17b sets the second score according to the comparison result between the standard deviation H_{FROstd,r} of the altitude and each of the third threshold Th_{UP′,r} and the fourth threshold Th_{DW′,r}. However, this is merely an example, and the second score calculating unit 17b may obtain a larger second score as the standard deviation H_{FROstd,r} is larger by substituting the standard deviation H_{FROstd,r} of the altitude into the multi-functional expression for calculating the second score.

The determination processing unit 17c acquires the first score from the first score calculating unit 17a and acquires the second score from the second score calculating unit 17b.

The determination processing unit 17c calculates a total index value Ind that is the sum of the first score and the second score.

Here, the determination processing unit 17c calculates the total index value Ind by adding the first score and the second score. However, this is merely an example, and the determination processing unit 17c may calculate the total index value Ind by weighting and adding the first score and the second score.

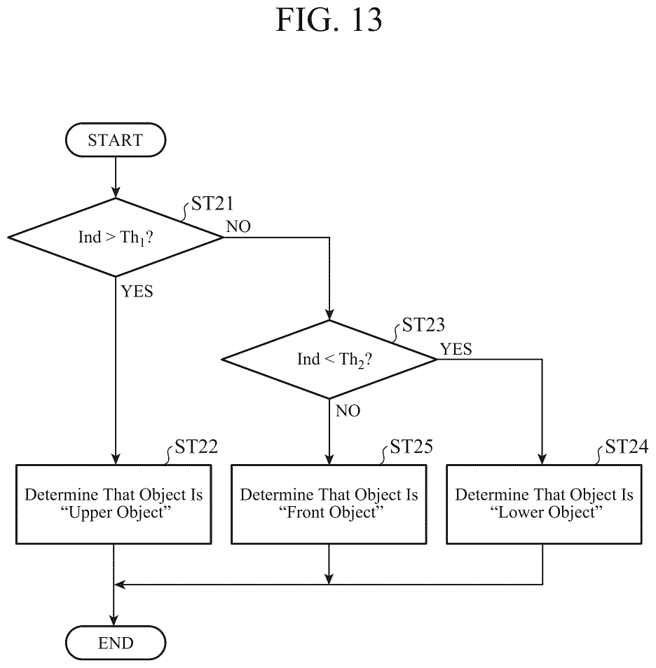

FIG. 13 is a flowchart illustrating determination processing of the determination processing unit 17c.

The determination processing unit 17c compares the total index value Ind with the first total threshold Th₁.

If the total index value Ind is larger than the first total threshold Th₁ (step ST21 in FIG. 13: YES), the determination processing unit 17c determines that an object present around the vehicle is an upper object (step ST22 in FIG. 13).

That is, the determination processing unit 17c determines that there is no object at a height at which there is a possibility of collision between the vehicle and the object. If the total index value Ind is equal to or smaller than the first total threshold Th₁ (step ST21 in FIG. 13: NO), the determination processing unit 17c compares the total index value Ind with the second total threshold Th₂.

If the total index value Ind is smaller than the second total threshold Th₂ (step ST23 in FIG. 13: YES), the determination processing unit 17c determines that an object present around the vehicle is a lower object (step ST24 in FIG. 13).

That is, the determination processing unit 17c determines that there is no object at a height at which there is a possibility of collision between the vehicle and the object.

If the total index value Ind is equal to or larger than the second total threshold Th₂ (step ST23 in FIG. 13: NO), the determination processing unit 17c determines that an object present around the vehicle is a front object (step ST25 in FIG. 13).

That is, the determination processing unit 17c determines that an object is present at a height at which there is a possibility of collision between the vehicle and the object.

The determination processing unit 17c outputs the determination result to the determination result output unit 5.

The determination result output unit 5 acquires the determination result of the collision determining unit 17 and outputs the determination result to, for example, the vehicle speed control device, which is not illustrated.

If the determination result of the collision determining unit 17 indicates that the object is present at a height at which there is a possibility of collision between the vehicle and the object, the vehicle speed control device controls the traveling speed of the vehicle in such a manner that the vehicle does not collide with the object, for example.

The signal processing device 4 illustrated in FIG. 1 includes both the range interval calculating unit 14 and the altitude standard deviation calculating unit 15, and the collision determining unit 17 determines whether or not an object is present at a height at which there is a possibility of collision between the vehicle and the object on the basis of the range interval ΔRₘ calculated by the range interval calculating unit 14 and the standard deviation H_{std} calculated by the altitude standard deviation calculating unit 15. However, this is merely an example, and it is also possible that the signal processing device 4 do not include the range interval calculating unit 14, and the collision determining unit 17 determines whether or not an object is present at a height at which there is a possibility of collision between the vehicle and the object on the basis of the standard deviation H_{std} calculated by the altitude standard deviation calculating unit 15.

In this case, if the standard deviation H_{FROstd,r} of the altitude is larger than the third threshold Th_{UP′,r} the collision determining unit 17 determines that the object present around the vehicle is an upper object. That is, the collision determining unit 17 determines that there is no object at a height at which there is a possibility of collision between the vehicle and the object.

If the standard deviation H_{FROstd,r} of the altitude is smaller than the fourth threshold Th_{DW′,r}, the collision determining unit 17 determines that the object present around the vehicle is a lower object. That is, the collision determining unit 17 determines that there is no object at a height at which there is a possibility of collision between the vehicle and the object.

When the standard deviation H_{FROstd,r} of the altitude is equal to or smaller than the third threshold Th_{UP′,r} and the standard deviation H_{FROstd,r} of the altitude is equal to or larger than the fourth threshold Th_{DW′,r}, the collision determining unit 17 determines that the object present around the vehicle is a front object. That is, the collision determining unit 17 determines that an object is present at a height at which there is a possibility of collision between the vehicle and the object.

In a case where the signal processing device 4 does not include the range interval calculating unit 14, the configuration can be simplified more than in a case where the signal processing device 4 includes both the range interval calculating unit 14 and the altitude standard deviation calculating unit 15.

In the first embodiment described above, the signal processing device 4 is configured to include the map generating unit 13 that acquires the reception signal of the reflected wave from the reception unit 1 that receives the reflected wave by the object present around the mobile object and generates the range Doppler map indicating the signal strength level of the reception signal, and the altitude standard deviation calculating unit 15 that calculates the standard deviation of the altitude at which the object is present on the basis of the range Doppler map generated by the map generating unit 13. Further, the signal processing device 4 includes the collision determining unit 17 to determine whether or not the object is present at a height at which there is a possibility of collision between the mobile object and the object on the basis of the standard deviation calculated by the altitude standard deviation calculating unit 15. Therefore, the signal processing device 4 can determine whether or not an object is present at a height at which there is a possibility of collision between the mobile object and the object on the basis of the reception signal of the reflected wave received by only one reception unit in the multipath environment.

Further, in the first embodiment, the signal processing device 4 is configured to include the range interval calculating unit 14 that calculates the range interval at which the direct wave from the object included in the reflected wave and the multipath wave from the object included in the reflected wave interfere with each other on the basis of the range Doppler map generated by the map generating unit 13. Furthermore, in the signal processing device 4, the collision determining unit 17 determines whether or not an object is present at a height at which there is a possibility of collision between the mobile object and the object on the basis of the range interval calculated by the range interval calculating unit 14 and the standard deviation calculated by the altitude standard deviation calculating unit 15. Therefore, the signal processing device 4 can improve the accuracy of the determination more than in a case of determining whether or not an object is present at a height at which there is a possibility of collision between the mobile object and the object on the basis of only the standard deviation.

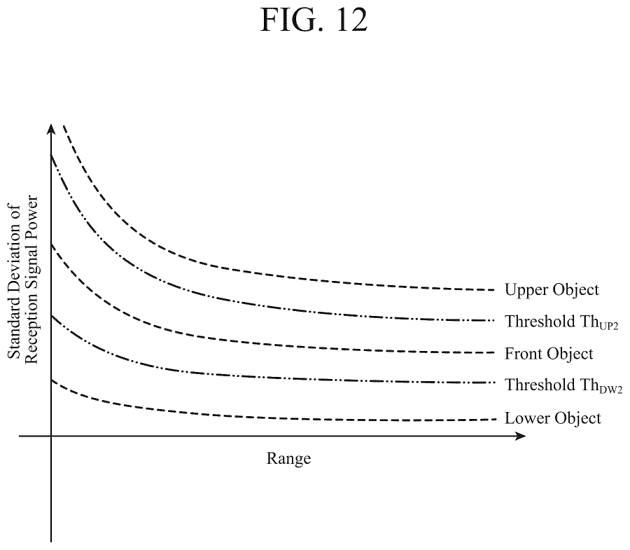

In the signal processing device 4 illustrated in FIG. 1, the second score calculating unit 17b of the collision determining unit 17 sets each of the third threshold Th_{UP′,r} and the fourth threshold Th_{DW′,r} using the standard deviation H_{FROstd,r} of the altitude for each ground range r. However, this is merely an example, and the second score calculating unit 17b may set each of the third threshold Th_{UP′,r} and the fourth threshold Th_{DW′,r} using the standard deviation of the reception signal power as illustrated in FIG. 12.

FIG. 12 is an explanatory diagram illustrating an example of standard deviations of reception signal power of respective reflected waves of an upper object, a front object, and a lower object which are objects.

In FIG. 12, the horizontal axis represents the relative distance between the vehicle and the object, and the vertical axis represents the standard deviation of the reception signal power.

As can be seen from FIG. 12, the standard deviation of the reception signal power is more likely to deteriorate due to the influence of the multipath wave as the altitude of the object is higher, similarly to the standard deviation of the altitude. Thus, the standard deviation of the reception signal power related to the upper object is larger than the standard deviation of the reception signal power related to the front object. Further, the standard deviation of the reception signal power related to the front object is larger than the standard deviation of the reception signal power related to the lower object.

In the example of FIG. 12, for each ground range r, a temporary threshold Th_{UP2,r} is set between the standard deviation of the reception signal power related to the upper object and the standard deviation of the reception signal power related to the front object. Furthermore, for each ground range r, a temporary threshold Th_{DW,r2} is set between the standard deviation of the reception signal power related to the front object and the standard deviation of the reception signal power related to the lower object.

For example, the second score calculating unit 17b calculates the third threshold Th_{UP′,r} by substituting the temporary threshold Th_{UP2,r} into the following Expression (23).

Further, the second score calculating unit 17b calculates the fourth threshold Th_{DW′,r}, for example, by substituting the temporary threshold Th_{DW2,r} into the following Expression (24).

$${Th}_{{UP}^{′} , r} = {P}_{5} \times {Th}_{UP 2 , r} + {P}_{6} \qquad ( 23 )$$

$${Th}_{{DW}^{′} , r} = {P}_{7} \times {Th}_{DW 2 , r} + {P}_{8} \qquad ( 24 )$$

In Expressions (23) to (24), each of P₅, P₆, P₇, and P₈ is a parameter for temporary threshold adjustment.

### Second Embodiment

In a second embodiment, the signal processing device 4 in a case where there is a plurality of objects having different azimuth angles with respect to the vehicle will be described.

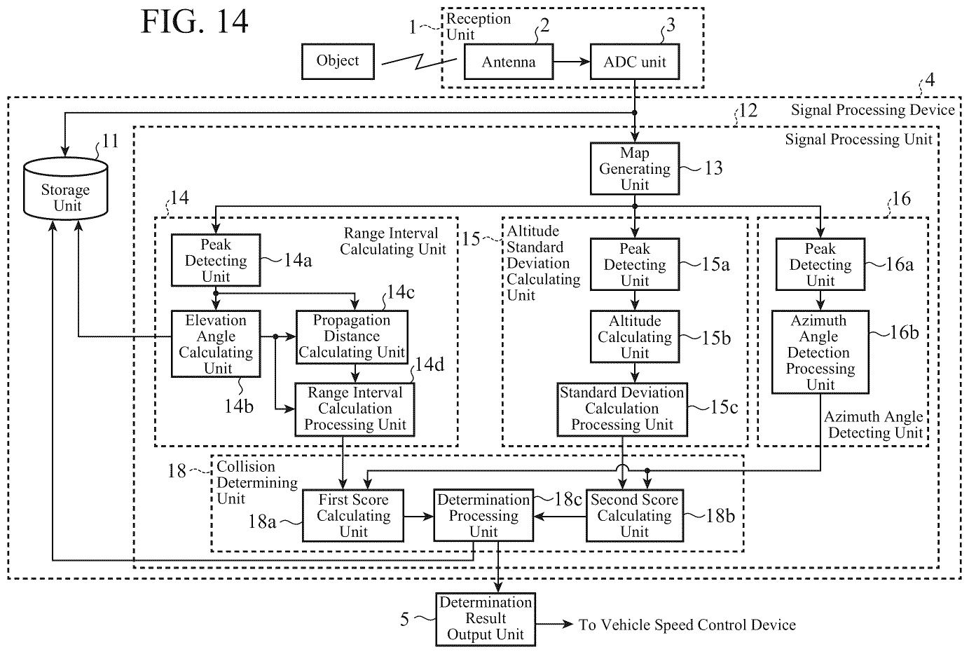

FIG. 14 is a configuration diagram illustrating a radar device according to the second embodiment.

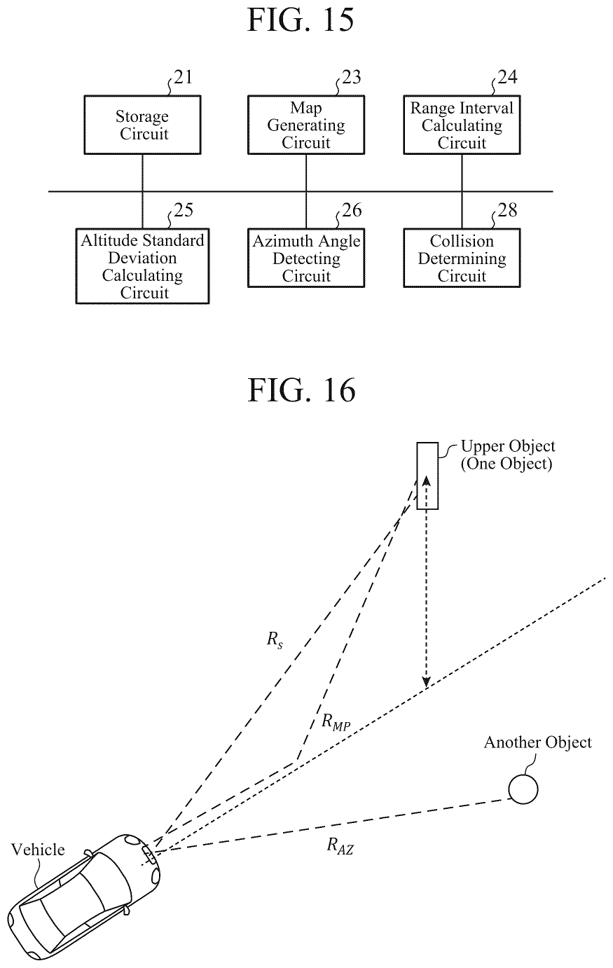

FIG. 15 is a hardware configuration diagram illustrating hardware of a signal processing device 4 according to the second embodiment.

The radar device illustrated in FIG. 14 includes the reception unit 1, the signal processing device 4, and the determination result output unit 5.

The signal processing unit 12 includes the map generating unit 13, the range interval calculating unit 14, the altitude standard deviation calculating unit 15, the azimuth angle detecting unit 16, and a collision determining unit 18.

The collision determining unit 18 is implemented by, for example, a collision determining circuit 28 illustrated in FIG. 15.

The collision determining unit 18 includes a first score calculating unit 18a, a second score calculating unit 18b, and a determination processing unit 18c.

The collision determining unit 18 specifies each of the azimuth angles of the plurality of objects on the basis of the azimuth angle information output from the azimuth angle detecting unit 16.

The collision determining unit 18 specifies an object whose azimuth angle coincides with the traveling direction of the vehicle among the plurality of objects.

For the specified object, the collision determining unit 18 determines whether or not an object is present at a height at which there is a possibility of collision between the vehicle and the object on the basis of the range interval calculated by the range interval calculating unit 14 and the standard deviation calculated by the altitude standard deviation calculating unit 15.

The collision determining unit 18 does not perform determination processing on an object whose azimuth angle does not coincide with the traveling direction of the vehicle.

The collision determining unit 18 outputs the determination result to the determination result output unit 5.

The first score calculating unit 18a specifies each of the azimuth angles of the plurality of objects on the basis of the azimuth angle information output from the azimuth angle detecting unit 16, and specifies an object whose azimuth angle coincides with the traveling direction of the vehicle among the plurality of objects.

The first score calculating unit 18a calculates the first score for the specified object according to the range interval calculated by the range interval calculating unit 14.

The first score calculating unit 18a outputs the first score to the determination processing unit 18c.

The second score calculating unit 18b specifies each of the azimuth angles of the plurality of objects on the basis of the azimuth angle information output from the azimuth angle detecting unit 16, and specifies an object whose azimuth angle coincides with the traveling direction of the vehicle among the plurality of objects.

The second score calculating unit 18b calculates the second score for the specified object according to the standard deviation calculated by the altitude standard deviation calculating unit 15.

The second score calculating unit 18b outputs the second score to the determination processing unit 18c.

Similarly to the determination processing unit 17c illustrated in FIG. 1, the determination processing unit 18c calculates a total index value that is a sum of the first score calculated by the first score calculating unit 18a and the second score calculated by the second score calculating unit 18b.

The determination processing unit 18c determines whether or not an object is present at a height at which there is a possibility of collision between the vehicle and the object on the basis of the comparison result between the total index value and the threshold.

In FIG. 14, it is assumed that each of the storage unit 11, the map generating unit 13, the range interval calculating unit 14, the altitude standard deviation calculating unit 15, the azimuth angle detecting unit 16, and the collision determining unit 18, which are components of the signal processing device 4, is implemented by dedicated hardware as illustrated in FIG. 15. That is, it is assumed that the signal processing device 4 is implemented by the storage circuit 21, the map generating circuit 23, the range interval calculating circuit 24, the altitude standard deviation calculating circuit 25, the azimuth angle detecting circuit 26, and the collision determining circuit 28.

Each of the map generating circuit 23, the range interval calculating circuit 24, the altitude standard deviation calculating circuit 25, the azimuth angle detecting circuit 26, and the collision determining circuit 28 corresponds to, for example, a single circuit, a composite circuit, a programmed processor, a parallel-programmed processor, ASIC, FPGA, or a combination thereof.

The components of the signal processing device 4 are not limited to those implemented by dedicated hardware, and the signal processing device 4 may be implemented by software, firmware, or a combination of software and firmware.

In a case where the signal processing device 4 is implemented by software, firmware, or the like, the storage unit 11 is configured on the memory 31 of the computer illustrated in FIG. 3. A program for causing a computer to execute processing procedures in the map generating unit 13, the range interval calculating unit 14, the altitude standard deviation calculating unit 15, the azimuth angle detecting unit 16, and the collision determining unit 18 is stored in the memory 31. Then, the processor 32 of the computer illustrated in FIG. 3 executes the program stored in the memory 31.

Furthermore, FIG. 15 illustrates an example in which each of the components of the signal processing device 4 is implemented by dedicated hardware, and FIG. 3 illustrates an example in which the signal processing device 4 is implemented by software, firmware, or the like. However, this is merely an example, and some components in the signal processing device 4 may be implemented by dedicated hardware, and the remaining components may be implemented by software, firmware, or the like.

FIG. 16 is an explanatory diagram illustrating a plurality of objects having different azimuth angles with respect to the vehicle.

In the example of FIG. 16, there are two objects, and one object is an upper object whose azimuth angle coincides with the traveling direction of the vehicle. The propagation distance of the direct wave from the upper object is R_{S}, and the propagation distance of the multipath wave from the upper object is R_{MP}.

The other object is an object whose azimuth angle does not coincide with the traveling direction of the vehicle. The distance between the vehicle and the other object is R_{AZ}.

In the example of FIG. 16, the reflected wave received by the antenna 2 includes a direct wave from the upper object, a multipath wave from the upper object, and a reflected wave from the other object.

In this case, a reception signal s′ of the antenna 2 is expressed by the following Expression (25).

$${s}^{′} = exp ( - j 2 π {f}_{0} \frac{{R}_{s}}{c} ) + {K}_{MP} exp ( - j 2 π {f}_{0} \frac{{R}_{MP}}{c} ) + {K}_{AZ} exp ( - j 2 π {f}_{0} \frac{{R}_{AZ}}{c} ) \qquad ( 25 )$$

In Expression (25), K_{AZ} represents a reflection coefficient.

When the direct wave from the upper object and the multipath wave from the upper object overlap with each other to cause the direct wave and the multipath wave to interfere with each other, the following Expression (26) holds. In a case where the multipath wave from the upper object and the reflected wave from the other object interfere with each other due to superposition of the multipath wave from the upper object and the reflected wave from the other object, the following Expression (27) holds.

Further, in a case where the direct wave from the upper object and the reflected wave from the other object interfere with each other, the following Expression (28) holds.

$$\begin{matrix}{R}_{s} - {R}_{MP} = {m}_{1} λ & ( {m}_{1} = 0 , \pm 1 , \pm 2 , ⋯ )\end{matrix} \qquad ( 26 )$$

$$\begin{matrix}{R}_{MP} - {R}_{AZ} = {m}_{2} λ & ( {m}_{2} = 0 , \pm 1 , \pm 2 , ⋯ )\end{matrix} \qquad ( 27 )$$

$$\begin{matrix}{R}_{s} - {R}_{AZ} = {m}_{3} λ & ( {m}_{3} = 0 , \pm 1 , \pm 2 , ⋯ )\end{matrix} \qquad ( 28 )$$

The range interval ΔRₘ₁ when the direct wave from the upper object and the multipath wave from the upper object interfere with each other can be calculated from the elevation angle θ_{EL,m1} related to the m₁-th ground range R_{g,m1} and the elevation angle θ_{EL,m1+1} related to the (m₁+1)-th ground range R_{g,m1+1} as expressed in the following Expression (29).

$$Δ {R}_{{m}_{1}} = {R}_{s , {m}_{1} + 1} - {R}_{s , {m}_{1}} = ( {H}_{T , {m}_{1}} - {H}_{R} ) ( \frac{1}{sin {θ}_{EL , {m}_{1} + 1}} - \frac{1}{sin {θ}_{EL , {m}_{1}}} ) \qquad ( 29 )$$

The range interval ΔRₘ₃ at which the direct wave from the upper object and the reflected wave from the other object interfere with each other can be calculated from the elevation angle θ_{EL,m3} related to the m₃-th ground range R_{g,m3} and the elevation angle θ_{EL,m3+1} related to the (m₃+1)-th ground range R_{g,m3+1} as expressed in the following Expression (30).

$$Δ {R}_{{m}_{3}} = {R}_{s , {m}_{3} + 1} - {R}_{s , {m}_{3}} = ( {H}_{T , {m}_{3}} - {H}_{R} ) ( \frac{1}{sin {θ}_{EL , {m}_{3} + 1}} - \frac{1}{sin {θ}_{EL , {m}_{3}}} ) \qquad ( 30 )$$

Next, the operation of the radar device illustrated in FIG. 14 will be described. The radar device is similar to the radar device illustrated in FIG. 1 except for the collision determining unit 18. Thus, only the operation of the collision determining unit 18 will be described here.

The first score calculating unit 18a of the collision determining unit 18 acquires the azimuth angle information from the azimuth angle detecting unit 16.

The first score calculating unit 18a specifies each of the azimuth angles of the plurality of objects on the basis of the azimuth angle information.

The first score calculating unit 18a determines whether or not the azimuth angle of each object coincides with the traveling direction of the vehicle.

When there is an object whose azimuth angle coincides with the traveling direction of the vehicle among the plurality of objects, the first score calculating unit 18a sets the first threshold Th_{UP,r} and the second threshold Th_{DW,r} for the object whose azimuth angle coincides with the traveling direction of the vehicle. The method of setting the first thresholds Th_{UP,r} and the like by the first score calculating unit 18a is similar to the method of setting the first thresholds Th_{UP,r} and the like by the first score calculating unit 17a illustrated in FIG. 1.

The first score calculating unit 18a calculates a first score for an object whose azimuth angle coincides with the traveling direction of the vehicle by a method similar to that of the first score calculating unit 17a illustrated in FIG. 1.

The first score calculating unit 18a does not calculate the first score for an object whose azimuth angle does not coincide with the traveling direction of the vehicle.

In the example of FIG. 16, the first score calculating unit 18a calculates the first score for the upper object and does not calculate the first score for another object.

The second score calculating unit 18b acquires the azimuth angle information from the azimuth angle detecting unit 16.

Similarly to the first score calculating unit 18a, the second score calculating unit 18b specifies each of the azimuth angles of the plurality of objects on the basis of the azimuth angle information, and determines whether or not the azimuth angle of each object coincides with the traveling direction of the vehicle.

When there is an object whose azimuth angle coincides with the traveling direction of the vehicle among the plurality of objects, the second score calculating unit 18b sets the third threshold Th_{UP′,r} and the fourth threshold Th_{DW′,r} for the object whose azimuth angle coincides with the traveling direction of the vehicle. The method of setting the third threshold Th_{UP′,r} and the like by the second score calculating unit 18b is similar to the method of setting the third threshold Th_{UP′,r} and the like by the second score calculating unit 17b illustrated in FIG. 1.

The second score calculating unit 18b calculates a second score for an object whose azimuth angle coincides with the traveling direction of the vehicle by a method similar to that of the first score calculating unit 17a illustrated in FIG. 1.

The second score calculating unit 18b does not calculate the second score for an object whose azimuth angle does not coincide with the traveling direction of the vehicle.

In the example of FIG. 16, the second score calculating unit 18b calculates the second score for the upper object and does not calculate the second score for another object.

Similarly to the determination processing unit 17c illustrated in FIG. 1, the determination processing unit 18c calculates a total index value that is a sum of the first score calculated by the first score calculating unit 18a and the second score calculated by the second score calculating unit 18b.

Similarly to the determination processing unit 17c illustrated in FIG. 1, the determination processing unit 18c determines whether or not an object is present at a height at which there is a possibility of collision between the vehicle and the object on the basis of the comparison result between the total index value and the threshold.

In the second embodiment described above, the signal processing device 4 illustrated in FIG. 14 is configured in such a manner that, when a plurality of objects is present around the mobile object, the collision determining unit 18 specifies an object whose azimuth angle detected by the azimuth angle detecting unit 16 coincides with the traveling direction of the mobile object among the plurality of objects, and determines whether or not the specified object is present at a height at which there is a possibility of collision with the mobile object. Therefore, similarly to the signal processing device 4 illustrated in FIG. 1, the signal processing device 4 illustrated in FIG. 14 can determine whether or not an object is present at a height at which there is a possibility of collision between the mobile object and the object on the basis of the reception signal of the reflected wave received by only one reception unit in the multipath environment. In addition, when a plurality of objects is present around the mobile object, the signal processing device 4 illustrated in FIG. 14 can determine only objects that may collide with the mobile object, and omit unnecessary determination processing.

Note that, in the present disclosure, free combinations of the embodiments, modifications of any components of the embodiments, or omissions of any components in the embodiments are possible.

### INDUSTRIAL APPLICABILITY

The present disclosure is suitable for a signal processing device, a signal processing method, and a radar device.

### REFERENCE SIGNS LIST

1: reception unit, 2: antenna, 3: ADC unit, 4: signal processing device, 5: determination result output unit, 11: storage unit, 12: signal processing unit, 13: map generating unit, 14: range interval calculating unit, 14a: peak detecting unit, 14b: elevation angle calculating unit, 14c: propagation distance calculating unit, 14d: range interval calculation processing unit, 15: altitude standard deviation calculating unit, 15a: peak detecting unit, 15b: altitude calculating unit, 15c: standard deviation calculation processing unit, 16: azimuth angle detecting unit, 16a: peak detecting unit, 16b: azimuth angle detection processing unit, 17: collision determining unit, 17a: first score calculating unit, 17b: second score calculating unit, 17c: determination processing unit, 18: collision determining unit, 18a: first score calculating unit, 18b: second score calculating unit, 18c: determination processing unit, 21: storage circuit, 23: map generating circuit, 24: range interval calculating circuit, 25: altitude standard deviation calculating circuit, 26: azimuth angle detecting circuit, 27: collision determining circuit, 28: collision determining circuit, 31: memory, 32: processor

1. A signal processing device comprising:
processing circuitry configured to
acquire a reception signal of a reflected wave from a receiver that receives the reflected wave by an object present around a mobile object, and generate a range Doppler map indicating a signal strength level of the reception signal;
calculate a standard deviation of an altitude at which the object is present on a basis of the generated range Doppler map;
calculate a range interval at which a direct wave from the object included in the reflected wave and a multipath wave from the object included in the reflected wave interfere with each other on a basis of a generated range Doppler map; and
determine whether or not the object is present at a height at which there is a possibility of collision between the mobile object and the object on a basis of the calculated standard deviation and the calculated range interval.

2. The signal processing device according to claim 1, wherein
the processing circuitry calculates an altitude at each of a plurality of times at which the object is present on a basis of the generated range Doppler map and calculates a standard deviation of the altitude from the altitudes at the plurality of times.

3. The signal processing device according to claim 1, wherein
the processing circuitry calculates a range interval at which the direct wave and the multipath wave intensify each other or a range interval at which the direct wave and the multipath wave weaken each other as the range interval at which the direct wave and the multipath wave interfere with each other.

4. The signal processing device according to claim 1, wherein
the processing circuitry is configured to calculate a first score according to the calculated range interval, calculate a second score according to the calculated standard deviation, calculate a total index value that is a sum of the first score and the second score, and determine whether or not the object is present at the height at which there is the possibility of collision between the mobile object and the object on a basis of a comparison result between the total index value and a threshold.

5. A signal processing device comprising:
processing circuitry configured to
acquire a reception signal of a reflected wave from a receiver that receives the reflected wave by an object present around a mobile object, and generate a range Doppler map indicating a signal strength level of the reception signal;
calculate a standard deviation of an altitude at which the object is present on a basis of the generated range Doppler map;
determine whether or not the object is present at a height at which there is a possibility of collision between the mobile object and the object on a basis of the calculated standard deviation;
detect an azimuth angle of the object with respect to the mobile object on a basis of the generated range Doppler map, and
determine whether or not the object is present at a height at which there is the possibility of collision between the mobile object and the object only when the detected azimuth angle coincides with a traveling direction of the mobile object.

6. The signal processing device according to claim 5, wherein
when there is a plurality of objects around the mobile object, processing circuitry specifies an object whose azimuth angle having been detected coincides with the traveling direction of the mobile object among the plurality of objects, and determines whether or not the specified object is present at the height at which there is the possibility of collision with the mobile object.

7. A signal processing method comprising:
acquiring a reception signal of a reflected wave from a receiver that receives the reflected wave by an object present around a mobile object, and generating a range Doppler map indicating a signal strength level of the reception signal;
calculating a standard deviation of an altitude at which the object is present on a basis of the generated range Doppler map;
calculating a range interval at which a direct wave from the object included in the reflected wave and a multipath wave from the object included in the reflected wave interfere with each other on a basis of a generated range Doppler map; and
determining whether or not the object is present at a height at which there is a possibility of collision between the mobile object and the object on a basis of the calculated standard deviation and the calculated range interval.

8. A radar device comprising:
a receiver to receive a reflected wave by an object present around a mobile object; and
processing circuitry configured to
acquire a reception signal of the reflected wave from the receiver, and generate a range Doppler map indicating a signal strength level of the reception signal;
calculate a standard deviation of an altitude at which the object is present on a basis of the generated range Doppler map;
calculate a range interval at which a direct wave from the object included in the reflected wave and a multipath wave from the object included in the reflected wave interfere with each other on a basis of a generated range Doppler map; and
determine whether or not the object is present at a height at which there is a possibility of collision between the mobile object and the object on a basis of the calculated standard deviation and the calculated range interval.
